(19) United States
(12) Patent Application Publication
(10) Pub. No.: US 2021/0321648 A1
(43) Pub. Date: Oct. 21, 2021

(54) ACOUSTIC TREATMENT OF FERMENTED FOOD PRODUCTS

(71) Applicant: John Martin, Chicago, IL (US)

(72) Inventor: John Martin, Chicago, IL (US)

(21) Appl. No.: 17/206,349

(22) Filed: Mar. 19, 2021

Related U.S. Application Data
(60) Provisional application No. 63/011,053, filed on Apr. 16, 2020.

(51) Int. Cl. A23L 5/30; A23L 29/00; C12C 11/00; H04R 1/44; G06F 3/16

(52) U.S. Cl. CPC A23L 5/32; A23L 29/06; C12C 11/00; H04R 3/00; G06F 3/165; A23V 2002/00; H04R 1/44

(57) ABSTRACT

Method for modifying a fermented food product by acoustically treating such product, or a precursor thereof, by exposing the same to sound. The acoustic sound may be either submerged or unsubmerged into the food product or beverage during fermentation. A fermented food product made using such a method.

### FIELD OF INVENTION

The present invention relates to a method for modifying a food product by acoustically treating such product or a precursor used to make such a product. Such acoustic treatment involves exposing the food product, or precursor thereof, to sound.

### BACKGROUND OF INVENTION

Fermentation is a biological process for extracting energy from molecules. During fermentation, carbohydrates are converted to alcohol, organic acids, carbon dioxide, and/or other metabolites.

Fermentation plays a central role in the production of various food products, including bread, buttermilk, cocoa, cheese, cured meats, fish sauce, kefir, kimchi, kombucha, kvass, miso, pickled vegetables, poi, sauerkraut, soy sauce, vinegar, yogurt, beer, cider, liquor, mead, mescal, sake, spirits, tequila, and wine. Fermentation is typically carried out by bacteria or fungi, such as yeast, present in the food product or a precursor of the food product.

In food processing, fermentation is used to convert carbohydrates in the food product (or a precursor used to make the food product) into alcohol, organic acids, carbon dioxide, and/or other metabolites, thus leading to changes in the taste, texture, aroma, and/or other properties of the food product. For example, wine is produced by way of fermentation of fruit juices, thus leading to the conversion of sugar in such juices to alcohol. Also, carbon dioxide produced by fermentation causes bread to leaven. Organic acids produced during the fermentation of milk cause the formation of yogurt and cheese. An additional benefit to fermentation is that the organic acid produced may serve to preserve the food product.

It is known in the art that sound has a role in the processing of food. For example, the growth of plants has been shown to be affected by sound. See Collins et al., Canadian Acoustics, 29(2) (2001) and Chatterjee et al., Asian J. Plant Sci. Res., 3:28-30 (2013). In fact, the type of music played has been shown to have different effects on the growth of plants. See Ekici et al., Asian Journal of Plant Sciences, 6:369-373 (2007). In addition, it has been demonstrated that the use of sound may accelerate the aging of wines. See Risen, C. (2012, Aug. 21). Rolling out a smaller barrel sooner. New York Times. p. D5. Sound has also been used to enhance the flavor of food. See U.S. Pat. No. 8,197,873.

Sound has been shown to affect fermentation. For example, it has been demonstrated to accelerate the growth of yeast and to significantly decrease fermentation time. See Aggio et al., Metabolomics, 8: 670-678 (2012), Jomdecha et al., In 12th Asia-Pacific Conference on NDT, 5-10 Nov. 2006, Auckland, New Zealand. In addition, sound has been shown to stimulate ethanol production. Klomklieng et al., IPCEE, 9:234-239 (2011). Sound has thus been used in the production of wine. An Austrian winemaker has loudspeakers on his vineyards and plays classical music for them day and night. See Kuderski, A., This Austrian Winemaker Is Using Music to Ferment His Wines. (2014 Dec. 23), Vice.

Applicant has discovered that the affect sound has on fermentation is related to the tempo of the music. For example, sound played at a tempo of about 80 to about 90 beats per minute (bpm) actually decreased the rate of sugar utilization as compared with the use of no sound at all. In contrast, the production of acids and certain other metabolites increased when sound having such a tempo was used. Without being bound by theory, it is believed that exposing a material to sound at the aforementioned tempo during fermentation leads to a slowing of fermentation which leads to a reduction in sugar consumption. This is in contrast to prior art findings that sound generally increases the rate of fermentation. At the same time, it is believed that the slowing of fermentation may allow for more time for the production of acids and other metabolites.

Meanwhile, applicant has also found that music having a tempo of about 130 to about 160 bpm increased the rate of utilization of sugar as compared with the use of no sound.

As acoustic treatment and the tempo of the sound used impacts the rate of sugar consumption and the production of acids and other metabolites, the termination of fermentation at a period of time before its completion allows one to achieve a final fermented food product having a desired sugar, acid, alcohol, and/or other metabolite content.

Applicant has thus developed a method for acoustically treating a fermented food product, or a precursor thereof, by exposing the product or precursor thereof to sound. By adjusting the tempo of the sound and the period of the fermentation, a final fermented food product having a desired sugar, acid, alcohol, and/or metabolite content can be produced.

### SUMMARY OF INVENTION

The present invention relates in part to a method for modifying a fermented food product, the method comprising: (A) exposing a fermented food product or precursor thereof to sound as it is undergoing fermentation; and (B) terminating the fermentation.

The present invention also relates in part to a fermented food product produced using such a method.

### BRIEF DESCRIPTION OF THE DRAWINGS

FIG. 1 depicts a set-up for acoustic treatment of a mixture contained in a container using an external speaker.

FIG. 2 depicts a set-up for acoustic treatment of a mixture contained in a container using a speaker submerged in the container.

FIG. 3 depicts the pH levels measured over time of a control batch, a batch acoustically treated using an external speaker, and a batch acoustically treated using a submerged speaker. Acoustic treatment was with sound at approximately 119-197 Hz, 92 bpm, and 100 dB.

FIG. 4 depicts the sugar levels measured over time in a control batch, a batch acoustically treated using an external speaker, and a batch acoustically treated using a submerged speaker. Acoustic treatment was with sound at approximately 119-197 Hz, 92 bpm, and 100 dB.

FIG. 5 depicts a UV spectrum analysis of aliquots from a control batch and a batch acoustically treated using a submerged speaker. Acoustic treatment was with sound at approximately 119-197 Hz, 92 bpm, and 100 dB.

FIG. 6 depicts the sugar levels measured over time in a control batch, a batch acoustically treated using an external speaker, and a batch acoustically treated using a submerged speaker. Acoustic treatment was with sound at approximately 230 Hz, 134-168 bpm, and 79 dB.

### DETAILED DESCRIPTION OF THE INVENTION

The present invention relates to a method for modifying the flavor of a food product by acoustically treating such a product or a precursor used to make such a product. Such acoustic treatment involves exposing the food product, or precursor thereof, to sound. A “precursor,” as used herein refers to any ingredient or any combination of the same (e.g., dough) used in the process of making the final fermented food product.

In an embodiment, the method comprises: (A) exposing a fermented food product or precursor thereof to sound as it is undergoing fermentation; and (B) terminating the fermentation.

In certain embodiments, the method further comprises recovering the fermented food product or precursor thereof.

The method may be applied to any food product produced or preserved by fermentation. Such food products are referred to herein as “fermented food products.” Examples of such fermented food products include bread, buttermilk, cocoa, cheese, cured meats, fish sauce, kefir, kimchi, kombucha, kvass, miso, pickled vegetables, poi, sauerkraut, soy sauce, vinegar, and yogurt. The fermented food product may be an alcoholic beverage such as beer, cider, liquor, mead, mescal, sake, spirits, tequila, or wine, or combinations thereof.

In some embodiments, depending on when fermentation occurs during the process for the production of the fermented food product, the acoustic treatment is applied to a precursor of that product. For example, the process for making cocoa involves the fermentation of cacao beans. As such, the method of the present invention may involve the acoustic treatment of the cacao beans that are later used to produce the final fermented food product, cocoa. For the sake of convenience, the present application will use the term “material” to refer to the fermented food product or precursor thereof that is subjected to acoustic treatment.

The invention contemplates the use of sound in any form. For example, the sound may, for example, be in the form of music, tones, infrasound, or ultrasound.

The sound may be produced by any device capable of producing a sound (referred to herein as an “acoustic device”). The acoustic device may, for example, be a speaker, a transducer, or a musical instrument.

In certain embodiments, the sound is produced by an audio input such as an MP3 player, a computer, a musical instrument, a radio, a tape player, or a microphone linked to the acoustic device.

As discussed previously, the tempo of the sound has effects on the consumption of carbohydrates and the production of acids and certain metabolites during fermentation. It is believed that the rate of fermentation is affected by the tempo of sound. As such, it is believed that the rate of carbohydrate consumption and the production of carbon dioxide, alcohol, and other metabolites produced during fermentation are affected. The metabolites produced may, for example, be organic acids, fusel oils, esters, aldehydes, glycerol, certain flavor compounds, and/or any other metabolite normally produced during fermentation.

Sound having a slower tempo, for example below 100 beats per minute (bpm), has been shown to decrease the rate of sugar consumption and increase the production of acids and certain metabolites. For example, the production of certain flavor compounds such as those having caramel notes was shown to be increased. It is believed that treatment using sound having such slower tempos also decreases alcohol and carbon dioxide production.

In certain embodiments, the tempo of the sound is below about 100 bpm, for example below about 95, below about 90, below about 85, below about 80, below about 79, below about 60, below about 50, below about 40, below about 30, below about 20, or below about 10 bpm. In certain embodiments, the tempo is between about 50 and about 100 bpm, between about 60 and about 100 bpm, between about 70 and about 100 bpm, between about 75 and about 95 bpm, or between about 80 and about 90 bpm.

Sound having a faster tempo, for example above 100 bpm, has been shown to increase the rate of sugar consumption and increase carbon dioxide and alcohol production. It is also expected to decrease production of acids and other metabolites.

In certain embodiments, the tempo of the sound is above about 100 bpm, for example above about 110 bpm, above about 150 bpm, above about 200 bpm, above about 250 bpm, or above about 300 bpm. In certain embodiments, the tempo is between about 100 and about 300 bpm, between about 100 and about 250 bpm, between about 100 and about 225 bpm, between about 100 and about 200 bpm, between about 120 and about 180 bpm, or between about 130 and about 160 bpm.

The invention contemplates that the sound may be of any decibel level as long as it is loud enough to have an effect on fermentation and not so loud as to be damaging to fermentation and/or the equipment. The decibel level of the sound may, for example, be from about 0.01 to about 1,000 dB, about 0.01 to about 500 dB, about 0.01 to about 200 dB, or about 100 dB.

The acoustic treatment can take place for as much time as required to achieve the desired effect on the material. For example, the treatment can be for more than 30 days, up to about 30 days, up to about 25 days, up to about 20 days, up to about 15 days, up to about 10 days, up to about 9 days, up to about 8 days, up to about 7 days, up to about 6 days, up to about 5 days, up to about 96 hours, up to about 84 hours, up to about 72 hours, up to about 60 hours up to about 48 hours, up to about 36 hours, up to about 24 hours, up to about 12 hours, up to about 6 hours, up to about 3 hours, up to about 2 hours, up to about 1 hour, or up to about a half hour. In certain embodiments, the acoustic treatment takes place over the entire course of fermentation, up to about 75% of the course of the fermentation, up to about 50% of the course of the fermentation, up to about 25% of the course of the fermentation, up to about 10% of the course of the fermentation, or up to about 5% of the course of the fermentation.

The invention contemplates that the sound may be of any frequency, including frequencies outside of the range audible to humans. For example, the sound may be ultrasound or infrasound. The frequency of the sound may, for example, be from about 10 to about 25,000 Hz, from about 10 to about 500 Hz, or from about 10 to about 250 Hz.

The material may be positioned at any distance from the acoustic device, as long as the acoustic waves from the source can be felt by the material. The material may, for example, be up to about 50 feet from the acoustic device. In certain embodiments, it is up to about 25 feet, up to about 20 feet, up to about 15 feet, up to about 10 feet, up to about 5 feet, up to about 3 feet, up to about 2 feet, up to about 1 feet, up to about 6 inches, up to about 3 inches, up to about 2 inches, or up to about 1 inch from the acoustic device.

In embodiments wherein the material to be subjected to acoustic treatment is in the form of a fluid, for example, a liquid, a solution, or a fluid mixture, the acoustic device may be submerged in the fluid. For example, in embodiments wherein the fluid is contained in a fermentation tank and the acoustic device is a speaker, the speaker may be submerged within the tank. Alternatively, the acoustic device may be external to the fluid, for example hung above it or at a position beside it.

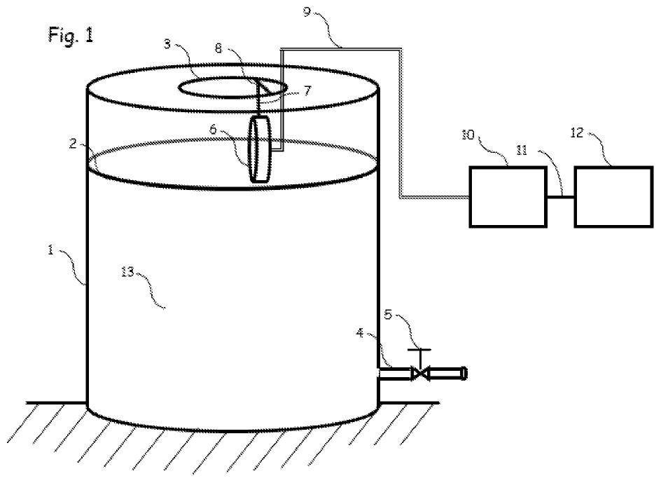

An example of a set up wherein the acoustic device is external to a fluid material that is being fermented is depicted in FIG. 1. In FIG. 1, the tank is a stainless steel fermentor 1. The tank in this example contains beer mash 13 that is filled to a mash fill line 2. The tank contains an open area 3 through which a speaker 6 is suspended using a stationary line 7 from a bracket 8 attached to the sides of the tank. The speaker serves as the acoustic device and is suspended above the mash fill line. The speaker is connected by way of a speaker wire 9 to an amplifier 10 and an audio input 12 by way of an audio input wire 11. The tank has a drain 4 which leads to a shut off valve 5.

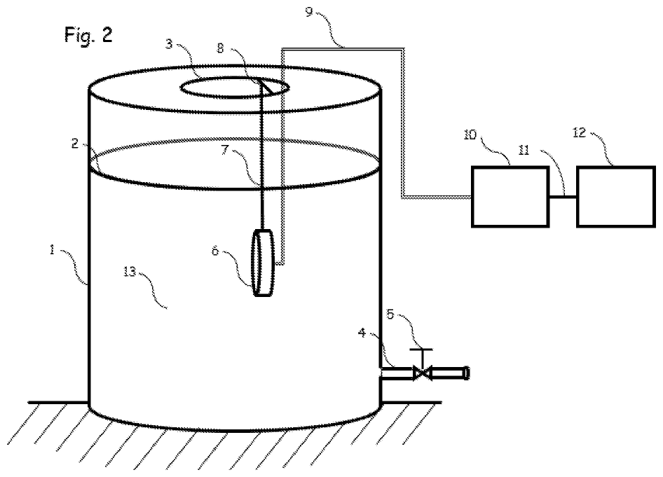

An example of a set up wherein the acoustic device is submerged in a fluid material that is being fermented is depicted in FIG. 2. In FIG. 2, the tank is a stainless steel fermentor 1. The tank in this example contains beer mash 13 that is filled to a mash fill line 2. The tank contains an open area 3 through which a speaker 6 is suspended using a stationary line 7. The speaker serves as the acoustic device and is suspended so that it is below the mash fill line and thus submerged in the beer mash when the tank is filled with the mash. The speaker is connected by way of a speaker wire 9 to an amplifier 10 and an audio input 12 by way of an audio input wire 11. The tank has a drain 4 which leads to a shut off valve 5.

In certain embodiments wherein the acoustic device is submerged in the fluid, it submerged so that it is less than about 20 feet, less than about 15 feet, less than about 10 feet, less than about 5 feet, or about 4 feet below the surface of the fluid.

In certain embodiments wherein the acoustic device is submerged in the fluid, the acoustic device is omnidirectional.

In certain embodiments wherein the acoustic device is submerged in the fluid, more than one acoustic device is present within the fluid. In such an embodiment, one acoustic device may be present, for example, every about 2,000 to about 8,000 square feet, every about 3,000 to about 7,000 square feet, or every about 4,500 to about 6,000 square feet of the fluid, or every 27,000 cubic feet an additional acoustic device can be used in tandem.

In certain embodiments, more than one material may be subjected to acoustic treatment simultaneously. For example, sound from one speaker can be used to treat a bread and a cheese that are both exposed to the same sound. Also, sound from a speaker submerged in a container containing wine may be used to also treat beer contained in another container. It may be further used to treat cheese that is in the same room and exposed to the same sound. In another embodiment, a cheese may be contained in a compartment that is submerged along with a speaker in a container containing wine with the sound from that speaker used to treat both the wine and the cheese.

As discussed previously, when the material to be treated is a fluid, it may be contained in a container. Examples of such containers include fermentation tanks. The container may, for example, have a volume of about 10 to about 100 gallons, about 20 to about 90 gallons, about 30 to about 80 gallons, about 40 to about 70 gallons, or about 55 gallons.

The material may comprise a microorganism and/or an enzymatic preparation (for example, containing amylase) to assist in the fermentation. For example, the material may be in the form of a fluid mixture containing such a microorganism and/or enzymatic preparation.

The microorganism may be a bacteria, a fungus such as yeast.

Fermentation may, for example, be terminated after about 96 hours, after about 72 hours, after about 60 hours, after about 48 hours, after about 36 hours, after about 24 hours, after about 12 hours, or after about 6 hours. Termination of fermentation may be accomplished by means known in the art, for example by thermal treatment (distillation for alcohol and pasteurization for dairy materials and beverages), freezing, or the use of pressure or heat.

In certain embodiments, acoustic treatment has the effect of increasing or decreasing the growth rate of the microorganism.

In certain embodiments, acoustic treatment has the effect of increasing or decreasing the yield of the fermented product.

The present invention also relates to a fermented food product produced using the method of the present invention. In certain embodiments, the fermented food product is bread, buttermilk, cocoa, cheese, cured meats, fish sauce, kefir, kimchi, kombucha, kvass, miso, pickled vegetables, poi, sauerkraut, soy sauce, vinegar, yogurt, beer, cider, liquor, mead, mescal, sake, spirits, tequila, or wine.

The ability of acoustic treatment to affect sugar, alcohol, and acid content and the amount of metabolites such as flavor compounds is useful in the flavoring of fermented food products, including any of the aforementioned products.

In addition, the ability of acoustic treatment to affect the production of carbon dioxide is useful in the process of making bread and cheese. For example, the carbon dioxide produced and the modification thereof by way of acoustic treatment will have an effect on the leavening of bread with less carbon dioxide produced leading to less leavened bread and more carbon dioxide produced leading to more leavened bread. Similarly, the amount of carbon dioxide produced and the modification thereof by way of acoustic treatment will have an effect on the structure of the cheese (e.g., the holes in Swiss cheese that are produced by carbon dioxide).

Further, the ability of acoustic treatment to affect the production of acid is useful in the process of making cheese, cured meats, kefir, kimchi, kombucha, pickled vegetables, sauerkraut, vinegar, and yogurt.

### EXAMPLES

### Example 1

Dry corn was ground using a hammer mill and then mixed with water to produce a slurry. This slurry was heated to 155° F. and other adjuncts (including rye and barley) added. The slurry was then allowed to cool. When the temperature of the slurry cooled to 145° F., enzymes were added to hydrolyze the starch and the temperature held for 60 to 90 minutes. The mixture was chilled to 100° F. and inoculated with an active commercial yeast strain capable of converting sugar into ethanol, carbon dioxide, and other flavor metabolites.

The inoculated mixture was divided into multiple open air fermenters. One batch received no acoustic treatment and served as the control. Another batch received acoustic treatment using a speaker external to the mixture. A third batch received acoustic treatment using a speaker submerged in the mixture. The acoustic treatment took place over 72 hours and involved sound at 119 to 197 Hz, 92 bpm (beats per minute), and 100 dB. The sound was played using a setup comprising an MP3 player (as audio input), amplifier, and speaker as depicted in FIG. 1 (for the external speaker) and FIG. 2 (for the submerged speaker). The contents of the fermentation tank were not stirred during the process.

Samples were collected and analyzed every 24 hours for pH and percent dissolved solids.

Acoustic processing at 119 to 197 Hz, 92 bpm (beats per minute), and 100 dB was found to impact pH and percent sugar of the resulting product versus control.

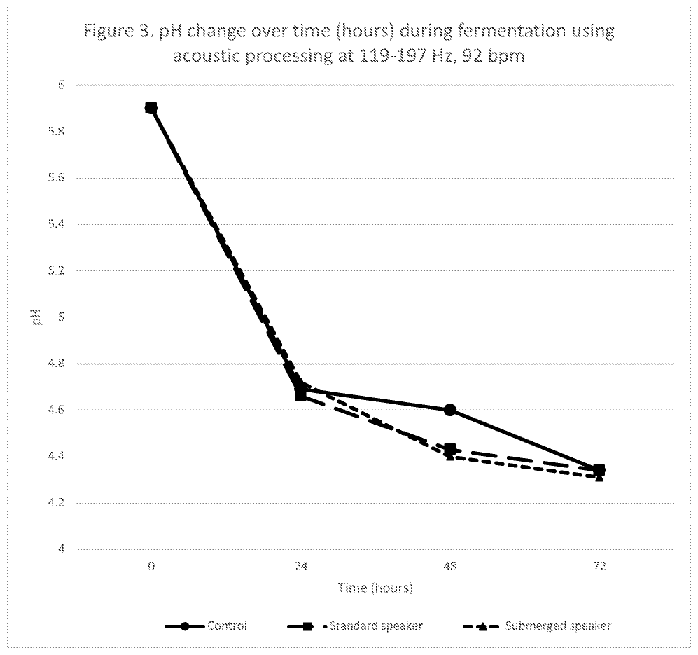

Acoustically-treated batches exhibited a more rapid decrease in pH, whether using an external or a submerged speaker, as compared to the control batch that was not acoustically treated. This is indicative of the greater acid production induced by acoustic treatment. These results are summarized in Table 1 and in FIG. 3.

TABLE 1
pH Change Over Time

| | 0 | 24 hours | 48 hours | 72 hours |
|---|---|---|---|---|
| Control | 5.9 | 4.69 | 4.6 | 4.34 |
| External Speaker | 5.9 | 4.66 | 4.43 | 4.34 |
| Submerged Speaker | 5.9 | 4.72 | 4.4 | 4.31 |

The increased acidity (lower pH) would result in a taste difference in the product with the final product tasting sourer.

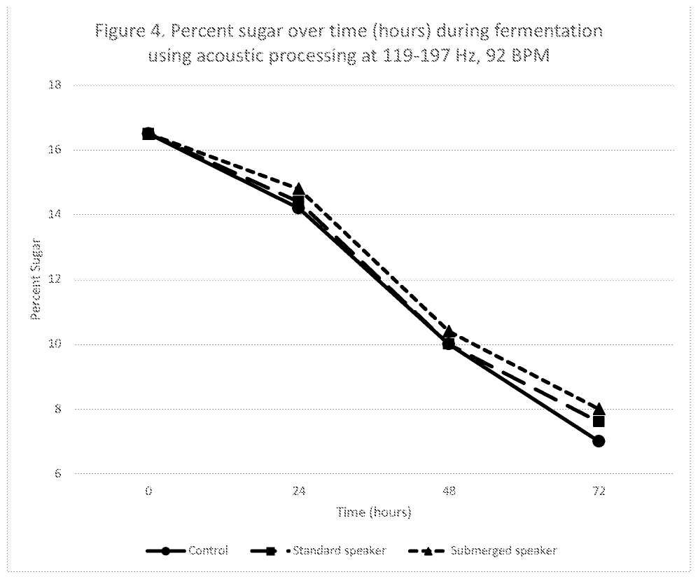

Acoustic treatment resulted in slower sugar consumption as compared to the control that was not acoustically treated. The batch treated using the submerged speaker exhibited a lower percent sugar decrease over the fermentation process as compared with the batch treated using the external speaker. These results are summarized in Table 2 and in FIG. 4.

TABLE 2
Percent Sugar Over Time

| | 0 | 24 hours | 48 hours | 72 hours |
|---|---|---|---|---|
| Control | 16.5 | 14.2 | 10 | 7 |
| External Speaker | 16.5 | 14.4 | 10 | 7.6 |
| Submerged Speaker | 16.5 | 14.8 | 10.4 | 8 |

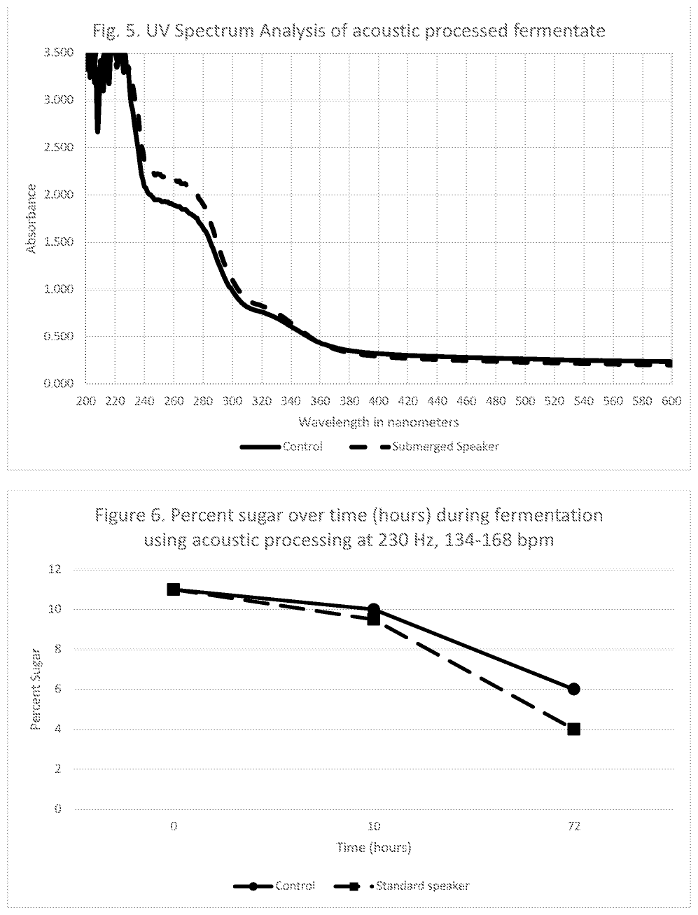

Aliquots of the control batch and the batch treated using the submerged speaker were analyzed using UV spectrum analysis of 200-600 nm wavelength to note compositional differences between the two batches (FIG. 5). There was a significant increase in flavor compounds noted at around 240-280 nm in the acoustically-treated sample (1-59-3) as compared with control (1-59-1). Compounds at this wavelength are typically associated with caramel notes.

After 72 hours of acoustic processing, the fermentate was then passed through a distillation column to remove ethanol.

Samples from the batches were filtered and refrigerated to slow further fermentation effects. The samples were tasted by expert panelists within 12 hours (Table 3).

TABLE 3
Expert panel taste comments (n = 3) of filtered
control (1-59-1) and submerged speaker samples
(1-59-3) after 72 hours of acoustic processing

| | Taste comments |
|---|---|
| Control sample (no acoustic | Beer like, earthy, cotton candy, corn |
| processing) | meal taste |
| Sample subjected to acoustic | Beer, earthy notes, brown caramelic, |
| processing using submerged | cooked notes. |
| speaker | |

### Example 2

The same process as described in Example 1 was used with different amounts of corn and adjuncts.

The inoculated mixture was divided into two open air fermenters. One batch received no acoustic treatment and served as the control. Another batch received acoustic treatment using a speaker external to the mixture. The acoustic treatment took place over 72 hours and involved sound at approximately 230 Hz, 134 to 168 bpm (beats per minute), and 79 dB. The sound was played using a setup comprising an MP3 player (as audio input), amplifier, and external speaker as depicted in FIG. 1. The contents of the fermentation tank were not stirred during the process.

Samples were collected and analyzed over time for percent dissolved solids.

Acoustic treatment resulted in faster sugar consumption as compared with the control that was not exposed to sound. These results are summarized in Table 4 and in FIG. 6.

TABLE 4
Percent Sugar Over Time

| | 0 | 10 hours | 72 hours |
|---|---|---|---|
| Control | 11 | 10 | 6 |
| External Speaker | 11 | 9.5 | 4 |

After 72 hours of acoustic processing, the fermentate was then passed through a distillation column to remove ethanol.

Samples from the batches were filtered and refrigerated to slow further fermentation effects. The samples were tasted by expert panelists within 12 hours (Table 5).

TABLE 5
Expert panel taste comments (n = 2) of filtered
control (1-48-1) and external speaker samples
(1-48-2) after 72 hours of acoustic processing

| | Taste comments |
|---|---|
| Control sample (no acoustic | Vegetative, herbal, bready, sweet |
| processing) | |
| Sample subjected to acoustic | Vegetative, astringent, harsher than |
| processing using external | control. |
| speaker | |

### Example 3

The same process as described in Example 1 was used with different amounts of corn and adjuncts.

The inoculated mixture was divided into two open air fermenters. One batch received no acoustic treatment and served as the control. Another batch received acoustic treatment using a speaker submerged in the mixture. The acoustic treatment took place over 72 hours and involved sound at approximately 230 Hz, 280 to 320 bpm (beats per minute), and 80 dB. The sound was played using a setup comprising an MP3 player (as audio input), amplifier, and a submerged speaker as depicted in FIG. 2. The contents of the fermentation tank were not stirred during the process.

Acoustic treatment resulted in faster sugar consumption as compared with the control that was not exposed to sound.

After 72 hours of acoustic processing, the fermentate was then passed through a distillation column to remove ethanol.

Samples from the batches were filtered and refrigerated to slow further fermentation effects. The samples were tasted by expert panelists within 12 hours (Table 6).

TABLE 6
Expert panel taste comments (n = 4) of filtered
control (1-68-1) and submerged speaker samples
(1-68-2) after 72 hours of acoustic processing

| | Taste comments |
|---|---|
| Control sample (no acoustic | Sweet, salty |
| processing) | |
| Sample subjected to acoustic | Astringent, harsher than control. |
| processing using submerged | |
| speaker | |

Although several embodiments of the disclosure are illustrated and described in connection with particular features and formulations, the present invention can be adapted for use with a wide variety of formulations. Other embodiments and equivalents have are envisioned within the scope of the claims. Various features of the disclosure have been particularly shown and described in connection with the illustrated embodiments. However, it must be understood that the particular embodiments merely illustrate, and that the invention is to be given its fullest interpretation within the terms of the claims.

1. A method for modifying a fermented food product, the method comprising:
a) exposing a fermented food product to a sound as it undergoes a fermentation; and
b) wherein said sound has a tempo ranging from 1 to 300 beats per minute.

2. The method of claim 1, wherein said sound had a decibel level from about 0.01 dB to about 200 dB.

3. The method of claim 1, wherein the acoustic treatment takes place for up to about 96 hours.

4. The method of claim 1, wherein the acoustic treatment takes place over the entire course of fermentation.

5. The method of claim 1, wherein the sound as a frequency of from about 10 to about 25,000 Hz.

6. The method of claim 1, wherein said fermented food product is a precursor of said fermented food product.

7. The method of claim 1, wherein said fermented food product is a liquid.

8. The method of claim 7, wherein said precursor is a liquid.

9. The method of claim 8, wherein said liquid is contained in a container and said sound is from a speaker submerged within said fluid.

10. The method of claim 1, wherein the fermented food product comprises a microorganism and/or an enzymatic preparation.

11. The method of claim 1, wherein the fermented food product comprises an enzymatic preparation.

12. The method of claim 10, wherein the microorganism is a bacteria.

13. The method of claim 10, wherein the microorganism is a fungus.

14. The method of claim 1, wherein said fermentation is terminated after about 72 hours.

15. The method of claim 1, further comprising recovering said fermented food product.

16. A fermented food product produced using the method of claim 1.

17. The fermented food product of claim 1, wherein the fermented food product is bread, buttermilk, cocoa, cheese, cured meats, fish sauce, kefir, kimchi, kombucha, kvass, miso, pickled vegetables, poi, sauerkraut, soy sauce, vinegar, yogurt, beer, cider, liquor, mead, mescal, sake, spirits, tequila, or wine.

18. A method for modifying a fermented food product, the method comprising:
a) exposing a fermented food product to a sound as it undergoes a fermentation;
b) said sound has a tempo ranging from 1 to 300 beats per minute;
c) said sound has a frequency of from about 10 to about 25,000 Hz; and
d) wherein the fermented food product comprises a microorganism.

19. A method for modifying a fermented food product, the method comprising:
a) exposing a fermented food product to a sound as it undergoes a fermentation;
b) said sound has a tempo ranging from 1 to 300 beats per minute;
c) said sound had a decibel level from about 0.01 dB to about 200 dB;
d) said sound has a frequency of from about 10 to about 25,000 Hz; and
e) the fermented food product comprises a microorganism; and
f) and wherein the sound is submerged into said food product.
